(19) United States
(12) Patent Application Publication
(10) Pub. No.: US 2025/0289262 A1
(43) Pub. Date: Sep. 18, 2025

(54) SYSTEM FOR A NESTED PAINT PAIL AND DUAL PAINT PAIL INSERTS

(71) Applicant: Ciarra Garland, Shreveport, LA (US)

(72) Inventor: Ciarra Garland, Shreveport, LA (US)

(21) Appl. No.: 18/602,306

(22) Filed: Mar. 12, 2024

(51) Int. Cl. B44D 3/12; B44D 3/14

(52) U.S. Cl. CPC B44D 3/121; B44D 3/122; B44D 3/127; B44D 3/128; B44D 3/14

(57) ABSTRACT

A nested paint pail system is disclosed including an outer paint pail having one or more paint pail inserts included in the outer paint pail cavity. The outer paint pail includes a magnet for attracting and affixing a paint brush to the outer paint pail surface. Paint pail inserts include a paint pail insert magnet positioned adjacent to outer paint pail magnet when the paint pail insert is included in the outer paint pail. In this arrangement, paint pail insert magnet is attracted to outer paint pail magnet, thereby, removably securing the paint pail insert inside the outer paint pail cavity.

### FIELD OF THE INVENTION

The present invention relates to nested paint pail system wherein a paint pail includes two nested paint pail inserts.

### BACKGROUND OF THE INVENTION

Painters engaged in interior projects often grapple with the need to paint surfaces using two different colors, a task that requires separate paint pails and separate paint brushes for each color. The cumbersome process of carrying and switching between multiple pails and multiple brushes becomes time-consuming, hindering the overall efficiency of the painting task.

The process becomes more challenging when painters must navigate ladders to paint the intersection of a ceiling and the wall. The repeated trips up and down the ladder increases the risk of accidents and injuries. The constant ascent and descent on ladders creates a hazardous environment for painters, as the probability of falls and injuries increases with each trip.

What is needed is a system that allows painters to transport two different colors and brushes simultaneously. Such a system would not only optimize the painting process by eliminating the need for frequent tool changes but the systems would also significantly enhance safety by reducing the time spent on ladders.

### BRIEF SUMMARY OF THE INVENTION

The present invention teaches a system for painting including an outer paint pail and dual nested paint pail inserts. In one aspect of the invention a paint pail is configured to hold two distinct paint pail inserts. The external shape of the paint pail inserts may be complementary shape of the cavity of the paint pail.

In one aspect of the invention the outer paint pail includes an outer paint pail magnet for use in holding a paint brush or securing a paint pail insert when included inside the outer paint pail cavity. The outer paint pail magnet may be affixed to a rear sidewall of the outer paint pail such that is capable of holding a paint brush or paint pail insert onto the outer paint pail rear sidewall. In one embodiment of the invention the outer paint pail magnet is affixed to the outer paint pail to hold a paint brush or paint pail in the interior volume of the paint pail (e.g., the outer paint pail cavity).

In another aspect of the invention the paint pails inserts have the same general shape as the paint pail, such that the paint pail inserts may fit inside the outer paint pail cavity. The shape of the paint pail insert is complementary to the shape of the outer paint pail cavity so that the paint pail insert may be inserted therein. The outer paint pail and paint pail inserts may be constructed to permit paint to be transported therein.

In yet another aspect of the invention the paint pail inserts may have a paint pail insert magnet included on a paint pail insert rear sidewall. The paint pail magnet may be such that it is magnetically attracted to the outer paint pail magnet to secure the paint pail inserts inside the outer paint pail. The paint pail insert magnet may be configured to attract and hold a conventional paint brush.

In still another aspect of the invention, the paint pail insert may include a pour spout at a paint pail insert front wall to permit the use to pour out the contents of the paint pail insert cavity.

Further still, in another aspect of the invention, the paint pail insert includes a paint insert handle at the paint insert rear sidewall for use in separating the paint pail insert magnet from the outer paint pail magnet to facilitate removal of the paint pail insert from the outer paint pail cavity.

### BRIEF DESCRIPTION OF THE DRAWING FIGURES

The present invention will be further explained with reference to the attached figures, wherein like structure and system elements are referred to by like reference numerals throughout the several views. It is contemplated that all descriptions are applicable to like and analogous structures throughout the several embodiments.

FIG. 1 is a side view of an outer paint pail according to various embodiments of the present invention.

FIG. 2 is an overhead depiction of an exemplary outer paint pail according to various embodiments of the present invention.

FIG. 3 is a front view of the front sidewall of an exemplary outer paint pail according to various embodiments of the present invention.

FIG. 4 is a front view of the rear sidewall of an exemplary outer paint pail according to various embodiments of the present invention.

FIG. 5 is a cross-section view of an exemplary outer paint pail magnet housing according to various embodiments of the present invention.

FIG. 6 is a front view of an exemplary outer paint pail magnet housing according to various embodiments of the present invention.

FIG. 7 is a top view of an exemplary outer pain pail magnet housing cover according to various embodiments of the present invention.

FIG. 8 is a cross-section view of an exemplary outer paint pail magnet housing cover according to various embodiments of the present invention.

FIG. 9 is a side view of an exemplary paint pail insert according to various embodiments of the present invention.

FIG. 10 is an overhead depiction of an exemplary paint pail insert that may be included in the outer paint pail cavity according to various embodiments of the present invention.

FIG. 11 is a side view of an exemplary paint pail insert magnet housing according to various embodiments of the present invention.

FIG. 12 is an overhead view of an exemplary paint pail insert lid according to various embodiments of the present invention.

FIG. 13 is a cross-section view of the paint pail insert lid according to various embodiments of the present invention.

FIG. 14 is a front view of the paint pail insert rear sidewall according to various embodiments of the present invention.

FIG. 15 is a side view showing how the paint pail insert may be included in the outer paint pail according to various embodiments of the present invention.

FIG. 16 is a cross-section view of an exemplary paint pail insert included in an exemplary outer paint pail according to various embodiments of the present invention.

FIG. 17 is an overhead view of multiple exemplary paint pail inserts included inside an exemplary outer paint pail cavity according to the various embodiments of the present invention.

FIG. 18 is an overhead view of a prior art paint brush that may be used with various embodiments of the present invention.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, rear, front, side, right, left, vertical, horizontal, etc., are used, it is to be understood that they are used only for ease of understanding the description. It is contemplated that the structures may be oriented otherwise.

### DETAILED DESCRIPTION OF THE INVENTION

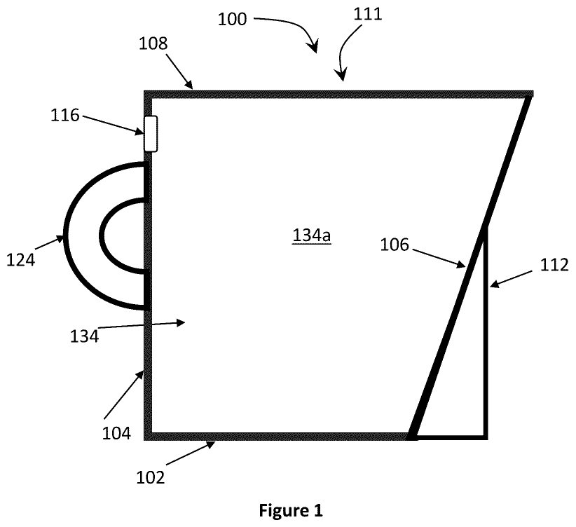

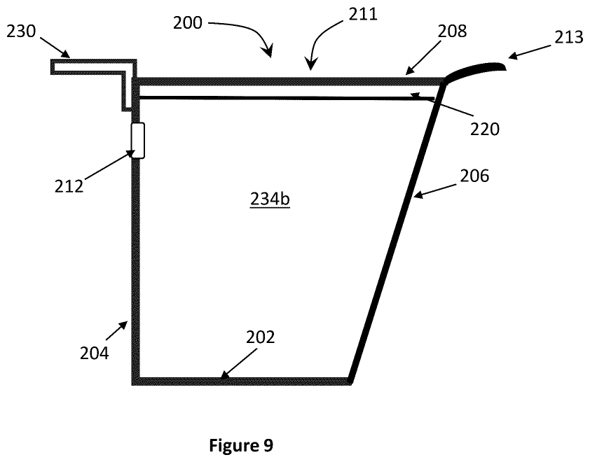

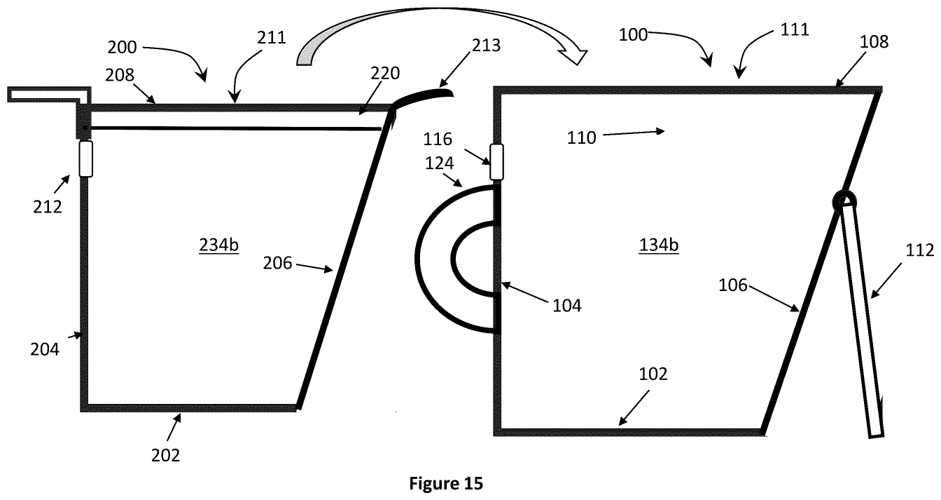

The present invention discloses a nested paint pail system, comprising an outer paint pail 100 (shown in FIG. 1) wherein multiple paint pail inserts 200 (shown in FIG. 11) may be inserted (shown in FIG. 9 and FIG. 15). Both outer paint pail 100 and paint pail inserts 200 are designed to be paint holding containers to be used with a paint brush or paint rollers. When not included inside outer paint pail 100, paint pail inserts 200 may be used independently from outer paint pail 100 to hold paint for painting with a paint brush or paint roller.

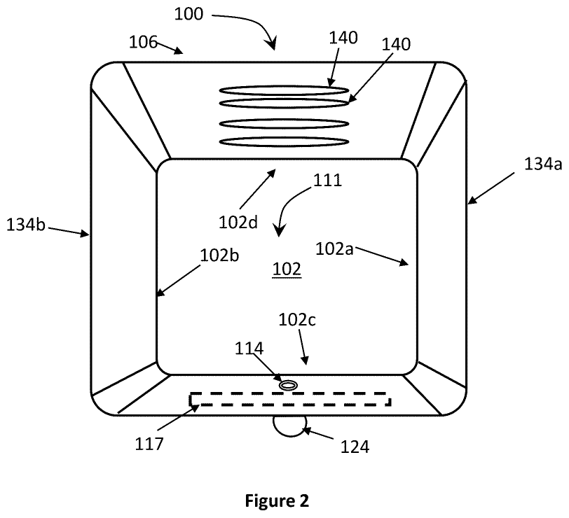

As shown in FIG. 1 and FIG. 2, outer paint pail 100 includes a planar bottom surface 102. In one embodiment, planar bottom surface 102 may be parallel to the surface upon which it sits. Outer pail 100 further includes a rear sidewall 104, a front sidewall 106, a left sidewall 134b, and a right sidewall 134a projecting upward from planar surface 102. Rear sidewall 104, front sidewall 106, left sidewall 134b, and right sidewall 134a may be planar. Rear sidewall 104, front sidewall 106, left sidewall 134a, and right sidewall 134b may be formed such that paint may flow down from rear sidewall 104, front sidewall 106, left sidewall 134b, and right sidewall 134a to planar surface 102.

In one particular embodiment, planar bottom surface 102 may include a bottom surface right edge 102a, a bottom surface left edge 102b, a bottom surface rear edge 102c, and a bottom surface front 102d. Front sidewall 106 may be projecting up from bottom surface front edge 102d. A rear sidewall 104 may be projecting up from bottom surface rear edge 102c. The top edge of the projected sidewalls 104, 106, 134a 134b may form outer paint pail top edge 108. A left sidewall 134a may be projecting up from bottom surface left edge 102b. A right sidewall 134a may be projecting up from bottom surface right edge 102a. In one embodiment, rear sidewall 104, front sidewall 106, left sidewall 134a, right sidewall 134b and planar surface 102 form an outer paint pail cavity 111 capable of holding paint, stain, varnish, adhesive, or the like.

In another embodiment of the invention, rear sidewall 104, front sidewall 106, left sidewall 134a, right sidewall 134b and planar bottom surface 102 may be comprised of a single material as a unitary structure. For example, outer paint pail 100 may be formed by injection molding using a polymer material that can withstand the chemicals included within outer pail 100 sidewalls. Particularly suitable materials include polypropylene and similar plastics.

Outer paint pail 100 may further include an outer paint pail handle 124 for use in carrying outer paint pail 100 from a first location to a second location. Outer paint pail handle 124 abuts, is in communication with, and affixed to rear surface 104. Outer paint pail handle 124 may be formed separately from outer paint pail 100, such that it is removable. For example, outer paint pail handle 124 may be removably attached to rear sidewall 104 using any conventional means for affixing similar structured. Exemplary affixing means may include using screws, rivets, brackets, structures that mate or the like. FIG. 2 depicts apertures 114 in rear sidewall 104. Apertures 114 may be used for affixing outer paint pail handle 124 to rear sidewall 104 using, for example using screws. Alternatively, outer paint handle 124 may be formed as part of an outer paint pail 100 in a unitary structure.

As shown in FIG. 2, front sidewall 106 may include a plurality of chevrons 140 for use in removing excess paint from a paint roller or paint brush. Chevrons 140 may be any conventional structure used to remove excess paint from a paint roller. Front sidewall 106 may form an angle with bottom planar surface 102. In one embodiment, front sidewall 106 may form an angle with planar bottom surface 102 to facilitate paint traveling from chevrons 140 to planar bottom surface 102.

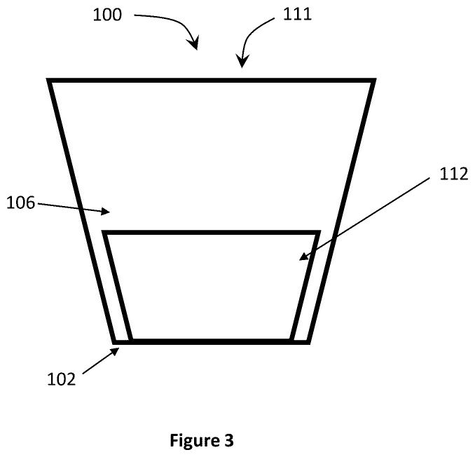

With reference to FIG. 1 and FIG. 3 (showing a front facing view of outer paint pail front sidewall 106), a support structure 112 is depicted affixed to front surface 106. Support structure 112 may be any structure capable of preventing outer paint pail 100 from tipping forward. In one example, support structure 112 may be a solid feature affixed to outer paint pail front sidewall 106. In another exemplary embodiment, support structure 112 may be a single leveling leg (as shown in FIG. 9), multiple leveling legs, scissoring brace supports, or the like, affixed to outer paint pail front sidewall 106.

FIG. 23 depicts a conventional paint brush 10 that may be used with the present invention. As shown, paint brush 10 may include a paint brush handle 1 for a painter to hold when using paint brush 10. Paint brush 10 may further include bristles 2 affixed to paint brush handle 1 for use in absorbing paint from outer paint pail cavity 111 and applying the paint to a surface, such as, a wall or ceiling. Paint brush 10 may further include a metal strip 3 overlaying the junction where bristles 2 are joined with paint brush handle 1. Metal strip 3 may be comprised of a ferromagnetic material that may be attracted, or may be magnetized, to a conventional magnet.

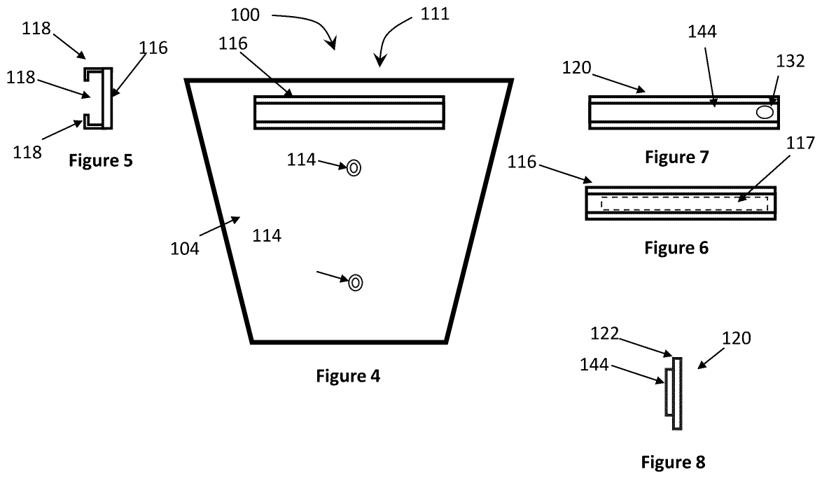

FIG. 4 displays a frontal view of rear surface 104, depicting an outer paint pail magnet housing 116 designed to include outer paint pail magnet 117 therein, as depicted in FIG. 6. This magnet, typically neodymium or ceramic, may consist of multiple magnets. Its primary function is to attract the paint brush metal strip 3, securing paint brush 10 onto rear sidewall 104 within the outer paint pail cavity 111. Enclosed within the magnet housing 116, the outer paint pail magnet 117 magnetizes the paint brush metal strip 3 through the rear sidewall 104 material. Furthermore, rear sidewall 104 features a recess 118 (illustrated in FIGS. 5 and 6) within the outer paint pail magnet housing 116, facilitating the placement of the outer paint pail magnet 117 therein. Additionally, the outer paint pail magnet housing 116 includes an outer paint pail magnet housing cover 120, as shown in FIG. 7, designed to seal the outer paint pail magnet 117 inside. Outer paint pail magnet cover 120 may be equipped with a housing cover protrusion 144 (depicted in FIG. 8) to secure the outer paint pail magnet 117 and a finger camber 132 for effortless installation and removal of outer paint pail magnet cover 120 onto outer paint pail magnet housing 116.

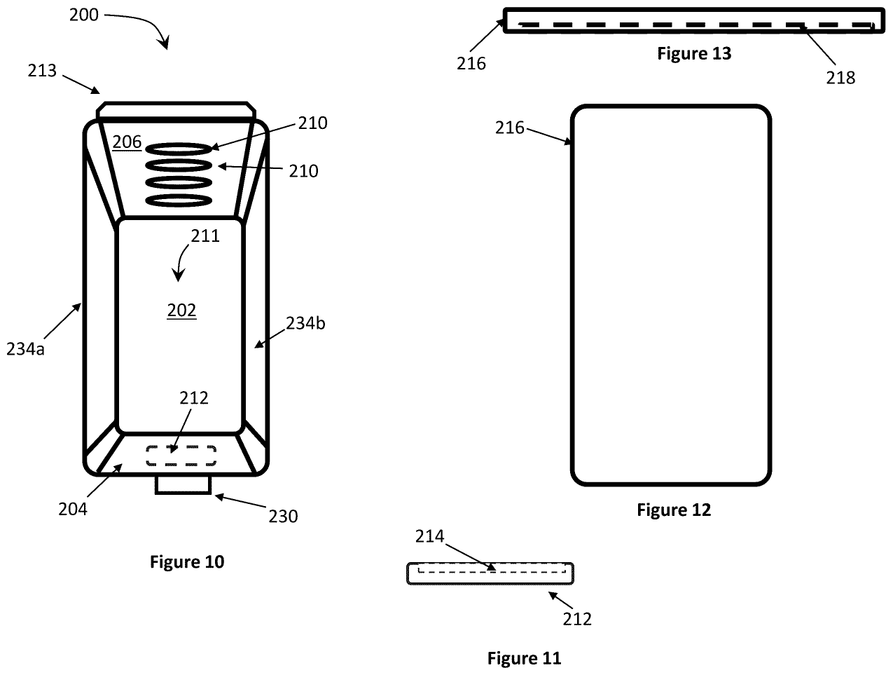

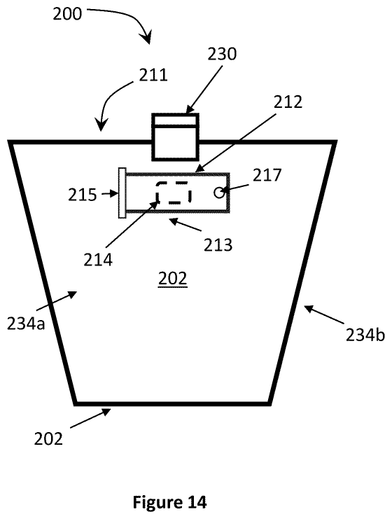

FIG. 9 and FIG. 10 depict paint pail insert 200 that may be inserted into outer paint pail cavity 111. Paint pail insert 200 includes a paint pail insert planar bottom surface 202. Paint pail insert 200 further includes a paint pail insert rear sidewall 204, a paint pail insert front sidewall 206, a paint pail insert left sidewall 234a, a paint pail insert front sidewall 206, and a paint pail insert right sidewall 234b, wherein paint pail insert rear sidewall 204, paint pail insert front sidewall 206, paint pail insert left sidewall 234a, paint pail insert front sidewall 206, and a paint pail insert right sidewall 234b project upward from paint pail insert planar bottom surface 202. The top ends of paint pail insert rear sidewall 204, paint pail insert front sidewall 206, paint pail insert left sidewall 234a, paint pail insert front sidewall 206, and paint pail insert right sidewall 234b may form a paint pail insert top edge 208. Paint pail insert rear sidewall 204, paint pail insert front sidewall 206, paint pail insert left sidewall 234a, paint pail insert right sidewall 234b, and planar bottom surface 202 form a paint pail insert cavity 211 in which paint, primer, or the like may be stored.

Paint pail insert 200 may further include a pour spout 213. Pour spout 213 may be adjacent to paint pail insert top edge 208. For example, pour spout 213 may be affixed to paint pail insert top edge 208 and further adjacent to paint pail insert front sidewall 206. In another embodiment, pour spout 213 may be made contiguous with paint pail insert 200. In still another exemplary embodiment, pour spout 213 may be made contiguous with paint pail insert top edge 208. Although the present invention is described with a pour spout 213, pour spout 213 may be a protruding ledge capable of facilitating removal of paint from paint pail insert 200.

Paint pail front sidewall 206 further may further include a plurality of paint pail insert chevrons 210 for use in removing excess paint from a paint roller or paint brush. Paint pail insert chevrons 210 may be any conventional structure used to remove excess paint from a paint roller as is known in the arts. The direction in which paint pail insert front sidewall 206 is projecting from paint pail insert planar bottom surface 202 may form an angle with paint pail insert planar bottom surface 202. In one embodiment, front sidewall 206 may form an angle with paint pail insert planar bottom surface 202 to facilitate paint traveling from paint pail insert chevrons 210 to paint pail insert planar bottom surface 202.

Paint pail insert rear sidewall 204 further includes a paint pail insert magnet housing 212 for housing a magnet in similar way as is discussed with outer paint pail magnet housing 116. As shown in FIG. 11, paint pail insert magnet housing 212 may include a paint pail insert magnet housing recess for receiving a paint pail insert magnet 214, therein. Paint pail insert magnet 214 may be of the same description as was described with respect to outer paint pail magnet 117.

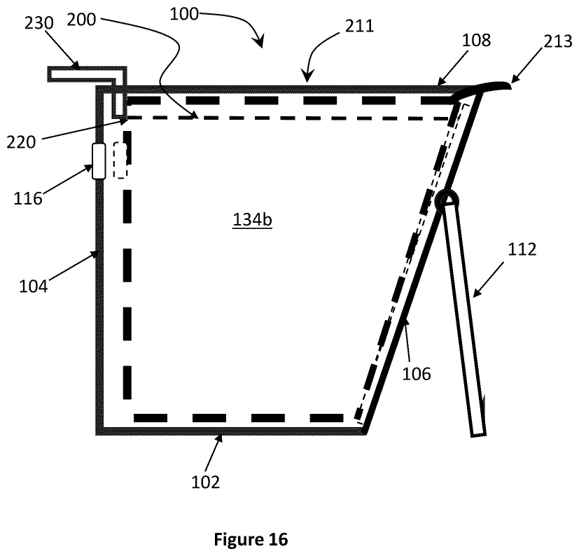

With brief reference to FIG. 16, a front facing view of paint pail insert rear sidewall 204 is shown. Paint pail insert rear sidewall 202 includes paint pail insert magnet housing 212. Paint pail insert magnet housing 212 includes a paint pail insert magnet housing cover 213 for securing a paint pail insert magnet 214, therein. Paint pail insert magnet housing door may include a hinge 215 for allowing paint pail insert magnet housing cover 213 to rotate away from paint pail insert rear sidewall 204 to allow access to paint pail insert magnet 214. Paint pail insert magnet housing 212 may further include a locking mechanism 217 for securing paint pail insert magnet housing cover 213 to paint pail insert magnet housing 212. In one exemplary embodiment, locking mechanism 217 may include a latch and hook, push latch, snap lock, or the like.

With reference now to FIG. 12 and FIG. 13 an exemplary paint pail insert lid 216 for securing to paint pail insert top edge 208 is depicted. Paint pail insert lid 216 may be of the same shape as paint pail insert top edge 208. Paint pail insert lid 216 may be secured to inner pain pail top edge 208 using any convention means for removably affixing a lid on a bucket, pail, or the like. In one exemplary embodiment, paint pail insert lid 216 may include a paint pail insert lid recess 218 for mating with a paint pail insert top edge rim 220 shown in FIG. 9. Paint pain insert top edge rim 220 may be concave or convex to permit paint pain insert top edge 208 to be inserted therein. In an alternate embodiment, paint pail insert lid 216 may be secured to paint pail insert top edge 208 by inserting a portion of paint insert lid 216 inside paint pail insert cavity 211.

As noted, the present invention teaches a nested paint pail system, wherein multiple paint pail inserts are included in an outer paint pail. The present invention comprises multiple paint pail inserts 200 included in the outer paint pail cavity 111. To facilitate this arrangement, in one exemplary embodiment, the shape of paint pail insert 200 is complimentary to the shape of outer paint pail 100 cavity 111.

FIG. 15 and FIG. 16 illustrates how a paint pail insert 200 may be included in outer paint pail cavity 111. As shown, the shape of paint pail insert 200 is complementary to shape of outer paint pail cavity 111. Paint pail insert 200 may be included in outer paint pail 100 such that paint insert handle 230 overhangs outer paint pail top edge 108. In one embodiment, paint inset handle 230 overhangs outer paint pail top edge 108 in proximity to (adjacent to) outer paint pail magnet housing 116 to facilitate removal of paint pail insert 100 from outer paint pail cavity 111. Paint pail insert 200 is included in outer paint pail 100 cavity 111 wherein paint pail insert magnet housing 212 is positioned adjacent to outer paint pail magnet housing 116. In the prescribed arrangement, paint pail insert magnet 214 is attracted to outer paint pail magnet 117 to secure paint pail insert 100 to outer paint pail 200.

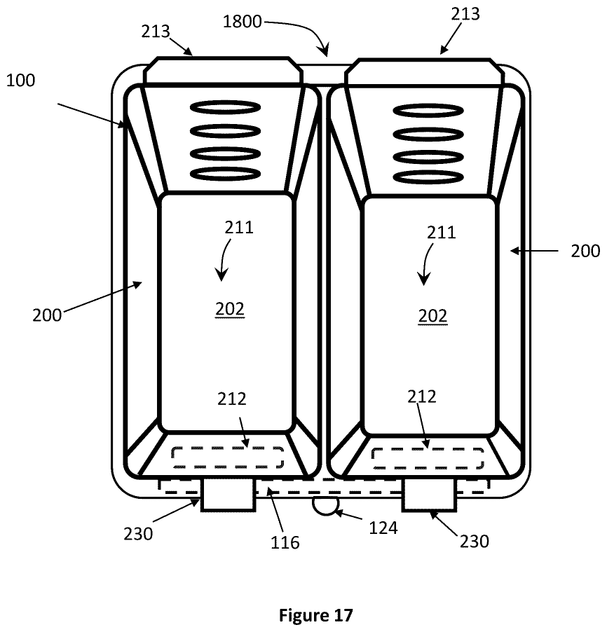

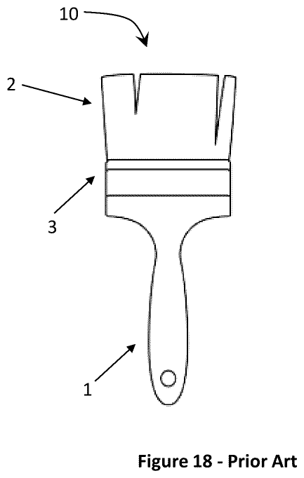

With reference to FIG. 17 a nested paint pail system 1700 according to the present invention is depicted. In the embodiment shown, outer paint pail 100 includes multiple paint pail inserts 200 in the outer paint pail cavity 111. The multiple paint pail inserts 200 may be positioned adjacent one to the other when included in outer paint pail cavity 111. The multiple paint pail inserts 200 may be included in outer paint pail cavity 111 such that each paint pail insert handle 230 overhangs outer paint pail top edge 108 to allow a painter to grab hold of paint pail insert handle 230 to remove paint pail insert 200, therefrom. In addition, The multiple paint pail inserts 200 may be included in outer paint pail cavity 111 such that each paint pail insert pour spout 213 overhangs outer paint pail top edge 108

Although the present invention is depicted showing 2 paint pail inserts 200 included in outer paint pail cavity 111, the invention contemplates more that 2 paint pail inserts may be included in outer paint pail cavity 111. Indeed, the present invention contemplates an embodiment wherein only 1 paint pail insert 200 is included in outer paint pail cavity 111. Further, although the bottom surfaces 102, 202 are described as planar, other shapes of bottom surfaces 102, 202 are considered within the scope of this invention.

During exemplary operation, a painter may fill a first paint pail insert 200 with one color pigment for painting a surface, and may fill a second paint pail insert 200 with a second color pigment for painting the same of different surface. The painter may use outer paint pail handle 124 to transport the nested paint pail system from one location to another. For example, the painter may use outer paint pail handle 124 to transport the nested paint pail system according to the present invention up a ladder or flight of stairs to a surface (or surfaces) to be painted. Once at the location to be painted, the painter may use paint brush 1 to facilitate painting by covering paint brush bristles 2 with a desired paint, and stroking the paint brush bristles 2 onto the surface to be painted.

When finished painting, or when at a pause in the painting, the painter may place paint brush 10 in proximity of paint pail insert magnet housing 212, thereby allowing paint pail insert magnet 214 to magnetize paint brush metal strip 3. In this way, paint brush 10 may be removably hold paint brush 10 onto paint pail rear sidewall 204. Where paint rollers are used, the paint roller may be filled with the paint included in paint pail insert cavity 211. Excess paint may be removed from the paint roller using paint pail insert chevrons 210 under any conventional method of paint removal.

While various features are presented above, it should be understood that the features may be used singly or in any combination thereof. Further, it should be understood that variations and modifications may occur to those skilled in the art to which the claimed examples pertain. For example, while the present invention discusses affixing the paint pail inserts to the outer paint pail cavity using magnets, it is understood that alternate embodiments of the invention contemplate that the paint pail inserts may be affixed to outer paint pail cavity using alternate affixing means. For example, the paint pail inserts according to the present invention may be affixed to the outer paint pail cavity by mating one portion of an outer paint pail sidewall to a portion of a paint pail insert sidewall without the need to use magnets. Moreover, the examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

1. A nested paint pail system comprising:
a. a paint pail having,
i. a planar bottom surface, the planar bottom surface having a bottom surface right edge, a bottom surface left edge, a bottom surface front edge and a bottom surface rear edge;
ii. a front sidewall projecting vertically upward from the bottom surface front edge to a front sidewall top edge, a right sidewall projecting vertically upward from the bottom surface right edge to a right sidewall top edge, a left sidewall projecting vertically upward from the bottom surface left surface edge to a left sidewall top edge, a rear sidewall projecting vertically upward from the bottom surface rear edge to a rear sidewall top edge;
iii. a paint pail top edge comprising the front sidewall top edge, the right sidewall top edge, the left sidewall top edge, and the rear sidewall top edge, wherein the planar bottom surface, the front sidewall, the right sidewall, the left sidewall, and the rear sidewall define a paint pail cavity;
iv. a paint pail magnet affixed to the rear side wall;
b. a first paint pail insert having,
i. a first paint pail insert bottom surface, the first paint pail insert bottom surface having a first paint pail insert bottom surface right edge, a first paint pail insert bottom surface left edge, a first paint pail insert bottom surface front edge and a first paint pail insert bottom surface rear edge;
ii. a first paint pail insert front sidewall projecting vertically upward from the first paint pail insert bottom surface front edge to a first paint pail insert front sidewall top edge, a first paint pail insert right sidewall projecting upward from the first paint pail insert bottom surface right edge to a first paint pail insert right sidewall top edge, a first paint pail insert left sidewall projecting vertically upward from the first paint pail insert bottom surface left surface edge to a first paint pail insert left sidewall top edge, a first paint pail insert rear sidewall extending vertically from the first paint pail insert bottom surface rear edge to a first paint pail insert rear sidewall top edge;
iii. a first paint pail insert top edge comprising the first paint pail insert front sidewall top edge, the first paint pail insert right sidewall top edge, the first paint pail insert left sidewall top edge, and the first paint pail insert rear sidewall top edge, wherein the first paint pail insert bottom surface, the first paint pail insert front sidewall, the first paint pail insert right sidewall, the first paint pail insert left sidewall, and the first paint pail insert rear sidewall define a first paint pail insert cavity;
iv. a first paint pail insert magnet affixed to the first paint pail insert rear sidewall;
wherein, the first paint pail insert is included in the paint pail cavity, such that, the paint pail magnet is positioned adjacent to the first paint pail insert magnet to affix the first paint pail insert in the paint pail cavity.

2. A nested paint pail system according to claim 1, wherein the first paint pail insert includes a first paint pail handle affixed to the first paint pail insert rear sidewall, wherein the first paint pail insert handle overhangs a portion of the paint pail top edge.

3. A nested paint pail system according to claim 1, wherein the first paint pail insert front sidewall includes chevrons for removing excess paint.

4. A nested paint pail system according to claim 1, wherein the first paint pail insert includes a pour spout affixed to the first paint pail insert front sidewall, wherein the first paint pail insert pour spout overhangs a portion of the paint pail top edge.

5. A nested paint pail system according to claim 1, wherein the paint pail front sidewall includes a stabilizing support member.

6. A nested paint pail system according to claim 1, further including a paint pail insert lid for removably affixing to first paint pail insert top edge.

7. A nested paint pail system according to claim 1, further comprising:
a. a second paint pail insert having,
i. a second paint pail insert bottom surface, the second paint pail insert bottom surface having a second paint pail insert bottom surface right edge, a second paint pail insert bottom surface left edge, a second paint pail insert bottom surface front edge and a second paint pail insert bottom surface rear edge;
ii. a second paint pail insert front sidewall projecting vertically upward from the second paint pail insert bottom surface front edge to a second paint pail insert front sidewall top edge, a second paint pail insert right sidewall projecting upward from the second paint pail insert bottom surface right edge to a second paint pail insert right sidewall top edge, a second paint pail insert left sidewall projecting vertically upward from the second paint pail insert bottom surface left surface edge to a second paint pail insert left sidewall top edge, a second paint pail insert rear sidewall extending vertically from the second paint pail insert bottom surface rear edge to a second paint pail insert rear sidewall top edge;
iii. a second paint pail insert top edge comprising the second paint pail insert front sidewall top edge, the second paint pail insert right sidewall top edge, the second paint pail insert left sidewall top edge, and the second paint pail insert rear sidewall top edge, wherein the second paint pail insert bottom surface, the second paint pail insert front sidewall, the second paint pail insert right sidewall, the second paint pail insert left sidewall, and the second paint pail insert rear sidewall define a second paint pail insert cavity;
iv. a second paint pail insert magnet affixed to the second paint pail insert rear sidewall;
wherein, the second paint pail insert is included in the paint pail cavity, such that, the paint pail magnet is positioned adjacent to the second paint pail insert magnet to affix the second paint pail insert in the paint pail cavity, and wherein the first paint pail insert is adjacent to the second paint pail insert when both are included in the paint pail cavity.

8. A nested paint pail system having an outer paint pail cavity, and plurality of paint pail inserts, the nested paint pail system comprising an outer paint pail including the outer paint pail cavity, wherein the plurality of paint pail inserts are removably affixed in the outer paint pail cavity, wherein the multiple paint pail inserts are removably affixed to the outer paint pail cavity using magnets.

9. A nested paint pail system having an outer paint pail cavity, and plurality of paint pail inserts, the nested paint pail system comprising an outer paint pail including the outer paint pail cavity, wherein the plurality of paint pail inserts are removably affixed in the outer paint pail cavity.

10. A nested paint pail system according to claim 9, wherein the plurality of paint pail inserts are removably affixed to the outer paint pail cavity using magnets.
